(19) United States
(12) Patent Application Publication
(10) Pub. No.: US 2025/0267535 A1
(43) Pub. Date: Aug. 21, 2025

(54) METHOD AND APPARATUS FOR REPORTING INFORMATION

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 18/858,136

(22) PCT Filed: Apr. 22, 2022
(86) PCT No.: PCT/CN2022/088635

§ 371 Date: Oct. 18, 2024

(51) Int. Cl. H04W 36/00

(52) U.S. Cl. CPC H04W 36/00835

(57) ABSTRACT

A method and apparatus for information reporting. A specified event occurs in a secondary cell group is detected, and secondary cell group failure information is transmitted to a network device. The secondary cell group failure information includes configuration information for a conditional primary secondary cell (PSCell) addition or change.

### CROSS-REFERENCE TO RELATED APPLICATIONS

The present application is a U.S. National Stage of International Application No. PCT/CN2022/088635, filed on Apr. 22, 2022, the contents of all of which are incorporated herein by reference in their entireties for all purposes.

### BACKGROUND OF THE INVENTION

In a 5G new radio (NR) system, a conditional primary secondary cell (PSCell) addition or change is supported, at most two triggered events for the conditional PSCell addition or change can be configured by a network, and the PSCell addition or change is initiated by user equipment (UE) after all the configured triggered events are fulfilled.

### SUMMARY OF THE INVENTION

Examples of the disclosure provide a method for reporting information. The method is performed by a terminal device, and includes:
detecting that a specified event occurs in a secondary cell group, and transmitting secondary cell group failure information to a network device, where
the secondary cell group failure information includes configuration information for a conditional primary secondary cell (PSCell) addition or change.

The examples of the disclosure provide a method for reporting information. The method is performed by a network device, and includes:
receiving secondary cell group failure information transmitted from a terminal device, where
the secondary cell group failure information includes configuration information for a conditional primary secondary cell (PSCell) addition or change.

The examples of the disclosure provide a communication apparatus. The apparatus includes one or more processors and a memory. The one or more processors are collectively configured to:
detect that a specified event occurs in a secondary cell group, and transmit secondary cell group failure information to a network device, where
the secondary cell group failure information comprises configuration information for a conditional primary secondary cell (PSCell) addition or change.

The examples of the disclosure provide a communication apparatus. The apparatus includes a processor and a memory. The memory stores a computer program. The processor executes the computer program stored in the memory, so as to cause the apparatus to execute the method for reporting information.

The examples of the disclosure provide a non-transitory computer-readable storage medium, configured to store an instruction. The instruction causes the method for reporting information to be implemented when executed.

Additional aspects and advantages of the disclosure will partially be set forth in the following description, will partially become apparent from the following description, or will be learned by practice of the disclosure.

### BRIEF DESCRIPTION OF DRAWINGS

In order to more clearly illustrate the examples of the disclosure or the technical solution in the prior art, the accompanying drawings required for the examples of the disclosure or the prior art will be explained below.

FIG. 1 is a schematic diagram of an architecture of a communication system according to an example of the disclosure;

FIG. 2 is a flowchart of a method for reporting information according to an example of the disclosure;

FIG. 3 is a flowchart of a method for reporting information according to an example of the disclosure;

FIG. 4 is a flowchart of a method for reporting information according to an example of the disclosure;

FIG. 5 is a flowchart of a method for reporting information according to an example of the disclosure;

FIG. 6 is a flowchart of a method for reporting information according to an example of the disclosure;

FIG. 7 is a schematic structural diagram of an apparatus for reporting information according to an example of the disclosure;

FIG. 8 is a schematic structural diagram of an apparatus for reporting information according to an example of the disclosure;

FIG. 9 is a schematic structural diagram of another apparatus for reporting information according to an example of the disclosure; and

FIG. 10 is a schematic structural diagram of a chip according to an example of the disclosure.

### DETAILED DESCRIPTION OF THE INVENTION

Description will be made in detail to examples here, and their instances are illustrated in the accompanying drawings. When the following description relates to the accompanying drawings, the same numbers in different accompanying drawings denote the same or similar elements, unless indicated otherwise. The embodiments described in the following examples do not represent all embodiments consistent with the disclosure. Rather, they are merely instances of apparatus and methods consistent with some aspects of the examples of the disclosure as detailed in the appended claims.

The terms used in the examples of the disclosure are for the purpose of describing particular examples merely and are not intended to limit the examples of the disclosure. As used in the examples and the appended claims of the disclosure, singular forms “a”, “an” and “the” are intended to include plural forms as well, unless otherwise clearly indicated in the context. It should also be understood that the term “and/or” as used here refers to and encompasses any or all possible combinations of one or more of associated items listed.

It should be understood that although the terms of first, second, third, etc. may be employed in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used here may be construed to mean “at the time of” or “when” or “in response to determining”, depending on the context.

Examples of the disclosure are described in detail below, and instances of the examples are illustrated in the drawings, in which same or similar reference numerals refer to the same or similar elements. The examples described below by reference to the drawings are illustrative for explaining the disclosure and are not to be construed as limiting the disclosure.

The disclosure relates to the technical field of communication, in particular to a method and apparatus for reporting information.

In order to better understand a method for reporting information disclosed in the examples of the disclosure, a communication system to which the example of the disclosure is applicable is first described below.

With reference to FIG. 1, FIG. 1 is a schematic diagram of an architecture of a communication system 100 according to an example of the disclosure. The communication system may include, but is not limited to, one first network device, one second network device and one terminal device. The number and form of devices shown in FIG. 1 are only illustrative and do not constitute a limitation to the example of the disclosure. The communication system may include two or more network devices and two or more terminal devices in an actual application. For example, the communication system shown in FIG. 1 includes one network device 101 and one terminal device 102.

It should be noted that the technical solution of the example of the disclosure can be performed by various communication systems, for example, a long term evolution (LTE) system, a fifth generation mobile communication system, a 5G new radio system, or other future new mobile communication systems, etc.

The network device 101 in the example of the disclosure is an entity on a network side for transmitting or receiving signals. For example, the network device 101 may be an evolved NodeB (eNB), a transmission reception point (TRP), a next generation NodeB (gNBs) in an NR system, a base station in other future mobile communication systems, or an access nodes in a wireless fidelity (WiFi) system, etc. The example of the disclosure does not limit a particular technology and a particular device form used by the network devices. The network device provided in the example of the disclosure may be composed of a central unit (CU) and a distributed unit (DU). The CU may also be referred to as a control unit. By using a CU-DU structure, protocol layers of the network device, such as a base station, may be split, functions of some protocol layers are centralized controlled by the CU, and functions of some or all of the remaining protocol layers are distributed in the DU, and the DU is centralized controlled by the CU.

The terminal device 102 in the example of the disclosure is an entity on a user side configured to receive or transmit signals, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a Pad, a computer with a radio transceiver function, a virtual reality (VR) terminal device, an augmented reality (AR) terminal device, a radio terminal device in industrial control, a radio terminal device in self-driving, a radio terminal device in remote medical surgery, a radio terminal device in a smart grid, a radio terminal device in transportation safety, a radio terminal device in a smart city, a radio terminal device in smart home, etc. The example of the disclosure does not limit a particular technology and a particular device configuration used by the terminal device.

In a 5G new radio (NR) system, a conditional primary secondary cell (PSCell) addition or change (CPAC) is supported, the network device 101 can configure at most two conditional triggered events for the conditional PSCell addition or change for the terminal device 102, and the PSCell addition or change is initiated by the terminal device 102 after all the configured triggered events are fulfilled.

Moreover, if the terminal device 102 detects a radio link failure (RLF) or detects a beam failure on a secondary cell group (SCG), an addition or change of the SCG fails, an SCG configuration failure occurs, or an integrity check failure occurs on the SCG, the terminal transmits an SCGFailureInformation message to a base station.

Currently, the SCGFailureInformation message only records a failure type, measurement results of a serving cell and a neighboring cell, a source PSCell ID in a PSCell change failure, a target PSCell ID, a time from execution of the PSCell change to occurrence of the SCG failure, and information related to a random access failure.

However, the SCGFailureInformation message includes no configuration information for a conditional PSCell addition or change (CPAC). The configuration information for the CPAC helps a network to be informed of whether a configuration for the conditional PSCell addition or change is reasonable, the network can conveniently optimize a configuration of conditional parameters.

It can be understood that the communication system described in the examples of the disclosure is for the purpose of more clearly illustrating the technical solutions provided in the examples of the disclosure, and does not constitute a limitation on the technical solutions provided in the examples of the disclosure. Those skilled in the art will know that the technical solutions provided in the examples of the disclosure are also applicable to similar technical problems along with evolution of a system architecture and emergence of new service scenes.

The method and apparatus for reporting information provided in the disclosure are described in detail below in conjunction with the accompanying drawings.

With reference to FIG. 2, FIG. 2 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 2, the method may include:

Step 201, detect that a specified event occurs in a secondary cell group, and transmit secondary cell group failure information to a network device, where the secondary cell group failure information includes configuration information for a conditional primary secondary cell (PSCell) addition or change.

In the example of the disclosure, the terminal device triggers reporting of the secondary cell group failure information on a condition that detect that the specified event occurs in the secondary cell group (SCG), the terminal device transmits the secondary cell group failure information to the network device. The secondary cell group failure information includes configuration information for a conditional PSCell addition or change.

In the example of the disclosure, the configuration information for the conditional PSCell addition or change includes at least one of the following:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

The serving cell and/or the at least one neighboring cell is a serving cell and/or at least one neighboring cell measured in the secondary cell group failure information.

The conditional configuration information for the conditional primary secondary cell (PSCell) addition or change refers to a conditional triggered event configured by the network device to the terminal device to trigger the PSCell addition or change.

In some embodiments, the conditional configuration information for the conditional primary secondary cell (PSCell) addition or change includes at least two conditional triggered events.

The triggered event information refers to information related to the conditional triggered event in the conditional configuration information for the conditional PSCell addition or change.

In some embodiments, the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

The first conditional triggered event and the second conditional triggered event are conditional triggered events included in the conditional configuration information for the conditional PSCell addition or change.

In the example of the disclosure, the configuration information for the conditional PSCell addition or change may be indicated by indication information in the secondary cell group failure information. For example, as an instance, the configuration information for the conditional PSCell addition or change may be indicated by an information element (IE) in the secondary cell group failure information. The IE may be newly defined. In some embodiments, an existing IE may also be reused to indicate the configuration information for the conditional PSCell addition or change.

In some embodiments, first indication information in the secondary cell group failure information is configured to indicate whether each cell of the serving cell and/or the at least one neighboring cell is the candidate cell for the conditional primary secondary cell (PSCell) addition or change.

In response to determining that the serving cell or the neighboring cell is the candidate cell for the conditional primary secondary cell (PSCell) addition or change, the first indication information is a first value.

In some embodiments, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, in some embodiments, the specified event includes at least one of the following, that is, the method provided in the example of the disclosure is applicable to at least one of the following situations of triggering reporting of the secondary cell group failure information:
a radio link failure for the secondary cell group (detecting radio link failure for the SCG);
a reconfiguration with synchronization failure of the secondary cell group (reconfiguration with sync failure of the SCG); or
detecting a beam failure of the primary secondary cell (PSCell) of the secondary cell group while the secondary cell group is deactivated (detecting beam failure of the PSCell while the SCG is deactivated).

Alternatively, in some embodiments, the specified event may further include at least one of the following, that is, the method provided in the example of the disclosure is further applicable to at least one of the following situations of triggering reporting the secondary cell group failure information:
an integrity check failure from secondary cell group lower layers concerning signaling radio bearer type 3 (SRB3) (integrity check failure indication from SCG lower layers concerning SRB3); or
a secondary cell group configuration failure (SCG configuration failure).

Alternatively, in some embodiments, the method provided in the example of the disclosure is inapplicable to a situation of detecting that at least one of the following events occurs in the secondary cell group, that is, the method is inapplicable to at least one of the following situations of triggering reporting of the secondary cell group failure information:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

It can be understood that in the example of the disclosure, the situation of triggering reporting of the secondary cell group failure information to which the method is applicable or inapplicable may be specified by a protocol or determined by an indication of the network device.

It should be noted that the secondary cell group (SCG) in the example of the disclosure may be an NR SCG or an evolved universal terrestrial radio access (EUTRA) SCG. If the SCG is an NR SCG, the secondary cell group failure information transmitted from the terminal device to the network device is SCGFailureInformation, that is, the configuration information for the conditional PSCell addition or change is included in the SCGFailureInformation. If the SCG is an EUTRA SCG, the secondary cell group failure information transmitted from the terminal device to the network device is SCGFailureInformationEUTRA, that is, the configuration information for the conditional PSCell addition or change is included in the SCGFailureInformationEUTRA.

Further, if the SCG is an NR SCG, the configuration information for the conditional PSCell addition or change may be included in measResultServingCell or measResultNeighcellListNR in MeasResultList2NR in MeasResultSCG-Failure in the SCGFailureInformation.

That is, the configuration information for the conditional PSCell addition or change may be included in SCGFailureInformation->MeasResultSCG-Failure->MeasResultList2NR ->measResultServingCell/measResultNeighCellListNR.

If the SCG is an EUTRA SCG, the configuration information for the conditional PSCell addition or change may be included in measResultServingCell or measResultNeighCellList in MeasResultList3EUTRA in measResultSCG-FailureMRDC in SCGFailureInformationEUTRA.

That is, the configuration information for the conditional PSCell addition or change may be included in SCGFailureInformationEUTRA->measResultSCG-FailureMRDC->MeasResultList3EUTRA->measResultServingCell/measResultNeighCellList.

In summary, the specified event occurs in the secondary cell group is detected, and the secondary cell group failure information may be transmitted to the network device. The secondary cell group failure information includes the configuration information for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

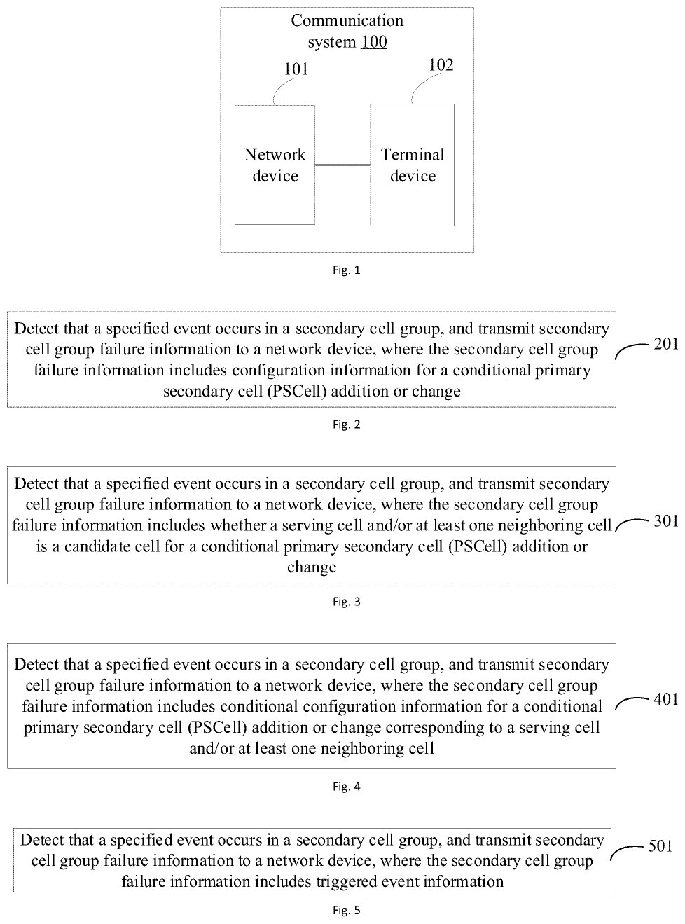

With reference to FIG. 3, FIG. 3 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 3, the method may include:

Step 301, detect that a specified event occurs in a secondary cell group, and transmit secondary cell group failure information to a network device, where the secondary cell group failure information includes whether a serving cell and/or at least one neighboring cell is a candidate cell for a conditional primary secondary cell (PSCell) addition or change.

In the example of the disclosure, the secondary cell group failure information transmitted from the terminal device to the network device includes whether a serving cell and/or at least one neighboring cell is a candidate cell for a conditional primary secondary cell (PSCell) addition or change.

In the example of the disclosure, whether a serving cell and/or at least one neighboring cell is a candidate cell for the PSCell addition or change may be indicated by first indication information in the secondary cell group failure information. For example, candidate cell list information may be indicated by an information element (IE) in the secondary cell group failure information. The IE may be newly defined. In some embodiments, an existing IE may also be reused.

As an instance, it is defined that the secondary cell group failure information includes an information element cpacCandidate, which is configured to indicate whether each cell of the serving cell and/or the at least one neighboring cell is the candidate cell for the conditional PSCell addition or change.

In response to determining that the serving cell or the neighboring cell is the candidate cell for the conditional PSCell addition or change, the first indication information is a first value.

As an instance, with neighboring cells as an instance, for each neighboring cell in a neighboring cell list, if the neighbor cell is the candidate cell for the conditional PSCell addition or change, cpacCandidate of the neighboring cell is set to be true.

A neighboring cell list of an NR SCG is measResultNeighcellListNR. Further, the neighboring cell list is measResultNeighcellListNR in MeasResultList2NR in MeasResultSCG-Failure.

A neighboring cell list of an EUTRA SCG is measResultNeighborCellList. Further, the neighboring cell list is measResultNeighCellList in MeasResultList3EUTRA in measResultSCG-FailureMRDC.

It should be noted that if the neighboring cell is the candidate cell for the conditional PSCell addition or change, a reconfigurationWithSync configuration included in secondaryCellGroup in condRRCReconfig is associated with the neighboring cell, that is, reconfigurationWithSync in the secondaryCellGroup in condRRCReconfig includes a cell identifier of the neighboring cell.

It can be understood that for the serving cell, indicating whether the serving cell is the candidate cell for the conditional PSCell addition or change is similar to the instance of the neighboring cells described above, which is not repeated here.

It can also be understood that in the example of the disclosure, if the serving cell or the neighboring cell is not the candidate cell for the conditional PSCell addition or change, the first indication information may be a second value, and alternatively, no first indication information may be needed for indication, that is, the secondary cell group failure information may include no first indication information.

Alternatively, in some embodiments, in response to a PSCell addition or change success, the configuration information for the conditional PSCell addition or change includes whether the serving cell and/or the at least one neighboring cell is the candidate cell for the conditional PSCell addition or change.

That is, in some embodiments, when the PSCell addition or change succeeds, the terminal device transmits to the network device whether the serving cell and/or the at least one neighboring cell is the candidate cell for the conditional PSCell addition or change.

Moreover, it should be noted that the secondary cell group (SCG) in the example of the disclosure may be an NR SCG or an EUTRA SCG. If the SCG is an NR SCG, the secondary cell group failure information transmitted from the terminal device to the network device is SCGFailureInformation, that is, the information element cpacCandidate is included in the SCGFailureInformation. If the SCG is an EUTRA SCG, the secondary cell group failure information transmitted from the terminal device to the network device is SCGFailureInformationEUTRA, that is, the information element cpacCandidate is included in the SCGFailureInformationEUTRA.

Further, if the SCG is an NR SCG, the information element cpacCandidate may be included in measResultServingCell or measResultNeighcellListNR in MeasResultList2NR in MeasResultSCG-Failure in the SCGFailureInformation.

If the SCG is an EUTRA SCG, the information element cpacCandidate may be included in measResultServingCell or measResultNeighCellList in MeasResultList3EUTRA in measResultSCG-FailureMRDC in SCGFailureInformationEUTRA.

In summary, the specified event occurs in the secondary cell group is detected, and the secondary cell group failure information is transmitted to the network device. The secondary cell group failure information includes whether a serving cell and/or at least one neighboring cell is a candidate cell for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

With reference to FIG. 4, FIG. 4 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 4, the method may include:

Step 401, detect that a specified event occurs in a secondary cell group, and transmit secondary cell group failure information to a network device, where the secondary cell group failure information includes conditional configuration information for a conditional primary secondary cell (PSCell) addition or change corresponding to a serving cell and/or at least one neighboring cell.

In the example of the disclosure, the secondary cell group failure information transmitted from the terminal device to the network device includes the conditional configuration information for the conditional primary secondary cell (PSCell) addition or change corresponding to the serving cell and/or the at least one neighboring cell.

The conditional configuration information for the conditional primary secondary cell (PSCell) addition or change refers to a conditional triggered event configured by the network device to the terminal device to trigger the PSCell addition or change.

In some embodiments, the conditional configuration information for the conditional primary secondary cell (PSCell) addition or change includes at least two conditional triggered events.

In the example of the disclosure, the conditional configuration information for the conditional primary secondary cell (PSCell) addition or change corresponding to the serving cell and/or the at least one neighboring cell may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, it is defined that the secondary cell group failure information includes an information element cpacConfig, which is configured to indicate the conditional configuration information for the conditional primary secondary cell (PSCell) addition or change corresponding to the serving cell and/or the at least one neighboring cell.

In some embodiments, in response to determining that the serving cell or the neighboring cell is the candidate cell for the conditional PSCell addition or change, second indication information in the secondary cell group failure information is configured to indicate the conditional configuration information for the conditional PSCell addition or change corresponding to the serving cell or the neighboring cell.

That is, the second indication information is configured to indicate the conditional triggered event that is configured by the network device for the terminal device, executes the addition or change of the serving cell or the neighboring cell, and needs to be fulfilled.

As an instance, with neighboring cells as an instance, for each neighboring cell in a neighboring cell list, if the neighbor cell is the candidate cell for the conditional PSCell addition or change, cpacConfig is set to the conditional configuration information associated with the neighboring cell in VarConditionalReconfig. The conditional configuration information associated with the neighboring cell in VarConditionalReconfig is condTriggerConfig corresponding to each Measld configured in condExecutionCond.

It should be noted that if the neighboring cell is the candidate cell for the conditional PSCell addition or change, a reconfigurationWithSync configuration included in secondaryCellGroup in condRRCReconfig is associated with the neighboring cell, that is, reconfigurationWithSync in the secondaryCellGroup in condRRCReconfig includes a cell identifier of the neighboring cell.

It can be understood that for the serving cell, indicating whether the serving cell is the candidate cell for the conditional PSCell addition or change is similar to the instance of the neighboring cells described above, which is not repeated here.

Moreover, it should be noted that the secondary cell group (SCG) in the example of the disclosure may be an NR SCG or an EUTRA SCG. If the SCG is an NR SCG, the secondary cell group failure information transmitted from the terminal device to the network device is SCGFailureInformation, that is, the information element cpacConfig is included in the SCGFailureInformation. If the SCG is an EUTRA SCG, the secondary cell group failure information transmitted from the terminal device to the network device is SCGFailureInformationEUTRA, that is, the information element cpacConfig is included in the SCGFailureInformationEUTRA.

Further, if the SCG is an NR SCG, the information element cpacConfig may be included in measResultServingCell or measResultNeighcellListNR in MeasResultList2NR in MeasResultSCG-Failure in the SCGFailureInformation.

If the SCG is an EUTRA SCG, the information element cpacConfig may be included in measResultServingCell or measResultNeighCellList in MeasResultList3EUTRA in measResultSCG-FailureMRDC in SCGFailureInformationEUTRA.

In summary, the specified event occurs in the secondary cell group is detected, and the secondary cell group failure information is transmitted to the network device. The secondary cell group failure information includes the conditional configuration information for the conditional primary secondary cell (PSCell) addition or change corresponding to the serving cell and/or the at least one neighboring cell, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

With reference to FIG. 5, FIG. 5 is a flowchart of a method for reporting information according to an example of the disclosure. It should be noted that the method for reporting information in the example of the disclosure is performed by the terminal device. The method may be performed independently or in conjunction with any one of other examples of the disclosure. As shown in FIG. 5, the method may include:

Step 501, detect that a specified event occurs in a secondary cell group, and transmit the secondary cell group failure information to a network device, where the secondary cell group failure information includes triggered event information.

In the example of the disclosure, the secondary cell group failure information transmitted from the terminal device to the network device includes triggered event information.

The triggered event information refers to information related to the conditional triggered event in the conditional configuration information for the conditional PSCell addition or change.

The conditional configuration information for the conditional primary secondary cell (PSCell) addition or change refers to a conditional triggered event configured by the network device to the terminal device to trigger the PSCell addition or change.

In the example of the disclosure, the triggered event information may be indicated by indication information in the secondary cell group failure information. For example, candidate cell list information may be indicated by an information element (IE) in the secondary cell group failure information. The IE may be newly defined. In some embodiments, an existing IE may also be reused.

As an instance, an information element triggeredEvent in the secondary cell group failure information is reused to indicate the triggered event information. It may be understood that in some embodiments, an IE may be newly defined to indicate the triggered event information.

In some embodiments, the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

The first conditional triggered event and the second conditional triggered event are conditional triggered events included in the conditional configuration information for the conditional PSCell addition or change.

As an instance, an information element condFirstEventFullfilled in the secondary cell group failure information is reused to indicate whether a first conditional triggered event is fulfilled.

An information element condSecondEventFullfilled in the secondary cell group failure information is reused to indicate whether a second conditional triggered event is fulfilled.

An information element firstTriggeredEvent in the secondary cell group failure information is reused to indicate the conditional triggered event fulfilled first.

An information element timeBetweenEvents in the secondary cell group failure information is reused to indicate the time interval between the conditional triggered event fulfilled first and the conditional triggered event fulfilled later.

It can be understood that in some embodiments, a newly defined IE may also be used to indicate the triggered event information.

In some embodiments, in response to the conditional configuration information for the condition PSCell addition or change, at least one conditional triggered event is fulfilled when the conditional configuration information is executed, or is fulfilled when a radio link failure occurs in the secondary cell group. Indication information corresponding to the fulfilled conditional triggered event is the first value.

As an instance, if the conditional triggered event (that is, the first conditional triggered event) corresponding to a first entry in the conditional configuration information is fulfilled when the conditional configuration information is executed or when a radio link failure occurs in the secondary cell group, condFirstEventFullfilled is set to be true.

If the conditional triggered event (that is, the second conditional triggered event) corresponding to a second entry in the conditional configuration information is fulfilled when the conditional configuration information is executed or when a radio link failure occurs in the secondary cell group, condSecondEventFullfilled is set to be true.

It can be understood that if both the conditional triggered event (that is, the first conditional triggered event) corresponding to the first entry and the conditional triggered event (that is, the second conditional triggered event) corresponding to the second entry in the conditional configuration information are fulfilled when the conditional configuration information is executed or when a radio link failure occurs in the secondary cell group, condFirstEventFullfilled is set to be true, and condSecondEventFullfilled is also set to be true.

In some embodiments, in response to the conditional configuration information for the condition PSCell addition or change, at least two conditional triggered events are fulfilled when the conditional configuration information is executed, or are fulfilled when a radio link failure occurs in the secondary cell group. The triggered event information includes a conditional triggered event fulfilled first, and a time interval between the conditional triggered event fulfilled first and a conditional triggered event fulfilled later.

As an instance, if both the conditional triggered event (that is, the first conditional triggered event) corresponding to the first entry and the conditional triggered event (that is, the second conditional triggered event) corresponding to the second entry in the conditional configuration information are fulfilled when the conditional configuration information is executed or when a radio link failure occurs in the secondary cell group, firstTriggeredEvent is set to be the conditional triggered event fulfilled first in the first conditional triggered event and the second conditional triggered event.

If both the conditional triggered event (that is, the first conditional triggered event) corresponding to the first entry and the conditional triggered event (that is, the second conditional triggered event) corresponding to the second entry in the conditional configuration information are fulfilled when the conditional configuration information is executed or when a radio link failure occurs in the secondary cell group, timeBetweenEvents is set to be the time interval between when the first conditional triggered event is fulfilled and when the second conditional triggered event is fulfilled.

It may be understood that in the example of the disclosure, if the conditional configuration information includes two conditional triggered events or more, the triggered event information may further include other information similar to the above information, such as whether a third conditional triggered event is fulfilled.

Moreover, it should be noted that the secondary cell group (SCG) in the example of the disclosure may be an NR SCG or an EUTRA SCG. If the SCG is an NR SCG, the secondary cell group failure information transmitted from the terminal device to the network device is SCGFailureInformation, that is, the information element triggeredEvent, and the condFirstEventFullfilled, the condSecondEventFullfilled, the firstTriggeredEvent and the timeBetweenEvents in the triggeredEvent are included in the SCGFailureInformation.

If the SCG is an EUTRA SCG, the secondary cell group failure information transmitted from the terminal device to the network device is SCGFailureInformationEUTRA, that is, the information element triggeredEvent, and the condFirstEventFullfilled, the condSecondEventFullfilled, the firstTriggeredEvent and the timeBetweenEvents in the triggeredEvent are included in the SCGFailureInformationEUTRA.

Further, if the SCG is an NR SCG, the information element triggeredEvent, and the condFirstEventFullfilled, the condSecondEventFullfilled, the firstTriggeredEvent and the timeBetweenEvents in the triggeredEvent may be included in measResultServingCell or measResultNeighcellListNR in MeasResultList2NR in MeasResultSCG-Failure in the SCGFailureInformation.

Further, if the SCG is an EUTRA SCG, the information element triggeredEvent, and the condFirstEventFullfilled, the condSecondEventFullfilled, the first TriggeredEvent and the timeBetweenEvents in the triggeredEvent may be included in measResultServingCell or measResultNeighCellList in MeasResultList3EUTRA in MeasResultSCG-FailureMRDC in the SCGFailureInformationEUTRA.

In summary, the specified event occurs in the secondary cell group is detected, and the secondary cell group failure information may be transmitted to the network device. The secondary cell group failure information includes the triggered event information, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

With reference to FIG. 6, FIG. 6 is a flowchart of a method for reporting information according to an example of the disclosure. It should be noted that the method for reporting information in the example of the disclosure is performed by a network device. The method may be performed independently or in conjunction with any one of other examples of the disclosure. As shown in FIG. 6, the method may include:

Step 601, receive secondary cell group failure information transmitted from a terminal device, where the secondary cell group failure information includes configuration information for a conditional primary secondary cell (PSCell) addition or change.

In the example of the disclosure, the terminal device triggers reporting of the secondary cell group failure information on a condition that detect that the specified event occurs in the secondary cell group (SCG), the network device receives the secondary cell group failure information transmitted from the terminal device. The secondary cell group failure information includes configuration information for a conditional PSCell addition or change.

In the example of the disclosure, the configuration information for the conditional PSCell addition or change includes at least one of:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

The serving cell and/or the at least one neighboring cell is a serving cell and/or at least one neighboring cell measured in the secondary cell group failure information.

The conditional configuration information for the conditional primary secondary cell (PSCell) addition or change refers to a conditional triggered event configured by the network device to the terminal device to trigger the PSCell addition or change.

In some embodiments, the conditional configuration information for the conditional primary secondary cell (PSCell) addition or change includes at least two conditional triggered events.

The triggered event information refers to information related to the conditional triggered event in the conditional configuration information for the conditional PSCell addition or change.

In some embodiments, the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

The first conditional triggered event and the second conditional triggered event are conditional triggered events included in the conditional configuration information for the conditional PSCell addition or change.

In the example of the disclosure, the configuration information for the conditional PSCell addition or change may be indicated by indication information in the secondary cell group failure information. For example, as an instance, the configuration information for the conditional PSCell addition or change may be indicated by an information element (IE) in the secondary cell group failure information. The IE may be newly defined. In some embodiments, an existing IE may also be reused to indicate the configuration information for the conditional PSCell addition or change.

In some embodiments, first indication information in the secondary cell group failure information is configured to indicate whether each cell of the serving cell and/or the at least one neighboring cell is the candidate cell for the conditional primary secondary cell (PSCell) addition or change.

In response to determining that the serving cell or the neighboring cell is the candidate cell for the conditional primary secondary cell (PSCell) addition or change, the first indication information is a first value.

Alternatively, in some embodiments, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

In some embodiments, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, in some embodiments, the specified event includes at least one of the following, that is, the method provided in the example of the disclosure is applicable to at least one of the following situations of triggering reporting of the secondary cell group failure information:
a radio link failure for the secondary cell group (detecting radio link failure for the SCG);
a reconfiguration with synchronization failure of the secondary cell group (reconfiguration with sync failure of the SCG); or
detecting a beam failure of the primary secondary cell (PSCell) of the secondary cell group while the secondary cell group is deactivated (detecting beam failure of the PSCell while the SCG is deactivated).

Alternatively, in some embodiments, the specified event may further include at least one of the following, that is, the method provided in the example of the disclosure is further applicable to at least one of the following situations of triggering reporting the secondary cell group failure information:
an integrity check failure from secondary cell group lower layers concerning signaling radio bearer type 3 (SRB3) (integrity check failure indication from SCG lower layers concerning SRB3); or
a secondary cell group configuration failure (SCG configuration failure).

Alternatively, in some embodiments, the method provided in the example of the disclosure is inapplicable to a situation of detecting that at least one of the following events occurs in the secondary cell group, that is, the method is inapplicable to at least one of the following situations of triggering reporting of the secondary cell group failure information:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

It can be understood that in the example of the disclosure, the situation of triggering reporting of the secondary cell group failure information to which the method is applicable or inapplicable may be specified by a protocol or determined by an indication of the network device.

It should be noted that the secondary cell group (SCG) in the example of the disclosure may be an NR SCG or an EUTRA SCG. If the SCG is an NR SCG, the secondary cell group failure information transmitted from the terminal device to the network device is SCGFailureInformation, that is, the configuration information for the conditional PSCell addition or change is included in the SCGFailureInformation. If the SCG is an EUTRA SCG, the secondary cell group failure information transmitted from the terminal device to the network device is SCGFailureInformationEUTRA, that is, the configuration information for the conditional PSCell addition or change is included in the SCGFailureInformationEUTRA.

Further, if the SCG is an NR SCG, the configuration information for the conditional PSCell addition or change may be included in measResultServingCell or measResultNeighcellListNR in MeasResultList2NR in MeasResultSCG-Failure in the SCGFailureInformation.

That is, the configuration information for the conditional PSCell addition or change may be included in SCGFailureInformation->MeasResultSCG-Failure->MeasResultList2NR ->measResultServingCell/measResultNeighCellListNR.

If the SCG is an EUTRA SCG, the configuration information for the conditional PSCell addition or change may be included in measResultServingCell or measResultNeighCellList in MeasResultList3EUTRA in measResultSCG-FailureMRDC in SCGFailureInformationEUTRA.

That is, the configuration information for the conditional PSCell addition or change may be included in SCGFailureInformationEUTRA->measResultSCG-FailureMRDC->MeasResultList3EUTRA->measResultServingCell/measResultNeighCellList.

In summary, the secondary cell group failure information transmitted from the terminal device is received. The secondary cell group failure information includes the configuration information for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

Corresponding to the method for reporting information provided in the above examples, the disclosure further provides an apparatus for reporting information. Since the apparatus for reporting information provided in the examples of the disclosure corresponds to the method provided in the above examples, an embodiment of the method for reporting information is also applicable to the apparatus for reporting information provided in the following examples, which will not be described in detail in the following examples.

With reference to FIG. 7, FIG. 7 is a schematic structural diagram of an apparatus for reporting information according to an example of the disclosure.

As shown in FIG. 7, the apparatus 700 for reporting information includes a transceiving unit 710.

The transceiving unit 710 is configured to detect that a specified event occurs in a secondary cell group, and transmit secondary cell group failure information to a network device.

The secondary cell group failure information includes configuration information for a conditional primary secondary cell (PSCell) addition or change.

Alternatively, the configuration information for the conditional primary secondary cell (PSCell) addition or change includes at least one of:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, the specified event includes at least one of:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, first indication information in the secondary cell group failure information is configured to indicate whether the serving cell and/or the at least one neighboring cell is the candidate cell for the conditional primary secondary cell (PSCell) addition or change.

In response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

According to the apparatus for reporting information in the example, the specified event occurs in the secondary cell group is detected, and the secondary cell group failure information may be transmitted to the network device. The secondary cell group failure information includes the configuration information for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

With reference to FIG. 8, FIG. 8 is a schematic structural diagram of an apparatus for reporting information according to an example of the disclosure.

As shown in FIG. 8, the apparatus 800 for reporting information includes a transceiving unit 810.

The transceiving unit 810 is configured to receive secondary cell group failure information transmitted from a terminal device.

The secondary cell group failure information includes configuration information for a conditional primary secondary cell (PSCell) addition or change.

Alternatively, the configuration information for the conditional primary secondary cell (PSCell) addition or change includes at least one of:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, first indication information in the secondary cell group failure information is configured to indicate whether the serving cell and/or the at least one neighboring cell is the candidate cell for the conditional primary secondary cell (PSCell) addition or change.

In response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the apparatus is applicable to a situation of detecting that at least one of the following events occurs in the secondary cell group:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

According to the apparatus for reporting information in the example, the secondary cell group failure information transmitted from the terminal device may be received. The secondary cell group failure information includes the configuration information for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

Examples in a first aspect of the disclosure provide a method for reporting information. The method is performed by a terminal device, and includes:
detecting that a specified event occurs in a secondary cell group, and transmitting secondary cell group failure information to a network device, where
the secondary cell group failure information includes configuration information for a conditional primary secondary cell (PSCell) addition or change.

Alternatively, the configuration information for the conditional primary secondary cell (PSCell) addition or change includes at least one of:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, the specified event includes at least one of:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, first indication information in the secondary cell group failure information is configured to indicate whether each cell of the serving cell and/or the at least one neighboring cell is the candidate cell for the conditional primary secondary cell (PSCell) addition or change, where
in response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the method is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

The examples in a second aspect of the disclosure provide a method for reporting information. The method is performed by a network device, and includes:
receiving secondary cell group failure information transmitted from a terminal device, where
the secondary cell group failure information includes configuration information for a conditional primary secondary cell (PSCell) addition or change.

Alternatively, the configuration information for the conditional primary secondary cell (PSCell) addition or change includes at least one of:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, first indication information in the secondary cell group failure information is configured to indicate whether the serving cell and/or the at least one neighboring cell is the candidate cell for the conditional primary secondary cell (PSCell) addition or change, where
in response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the method is applicable to a situation of detecting that at least one of the following events occurs in the secondary cell group:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, the method is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

The examples in a third aspect of the disclosure provide an apparatus for reporting information. The apparatus is applied to a terminal device, and includes:
a transceiving unit configured to detect that a specified event occurs in a secondary cell group, and transmit secondary cell group failure information to a network device, where
the secondary cell group failure information includes configuration information for a conditional primary secondary cell (PSCell) addition or change.

Alternatively, the configuration information for the conditional primary secondary cell (PSCell) addition or change includes at least one of the following:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, the specified event includes at least one of the following:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, first indication information in the secondary cell group failure information is configured to indicate whether the serving cell and/or the at least one neighboring cell is the candidate cell for the conditional primary secondary cell (PSCell) addition or change, where
in response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

The examples in a fourth aspect of the disclosure provide an apparatus for reporting information. The apparatus is applied to a network device, and includes:
a transceiving unit configured to receive secondary cell group failure information transmitted from a terminal device, where
the secondary cell group failure information includes configuration information for a conditional primary secondary cell (PSCell) addition or change.

Alternatively, the configuration information for the conditional primary secondary cell (PSCell) addition or change includes at least one of the following:
whether a serving cell and/or at least one neighboring cell is a candidate cell for the conditional primary secondary cell (PSCell) addition or change;
conditional configuration information for the conditional primary secondary cell (PSCell) addition or change corresponding to the serving cell and/or the at least one neighboring cell; or
triggered event information.

Alternatively, the conditional configuration information for the conditional primary secondary cell (PSCell) addition or change includes at least two conditional triggered events, and the triggered event information includes:
whether a first conditional triggered event is fulfilled;
whether a second conditional triggered event is fulfilled;
a conditional triggered event fulfilled first; and
a time interval between the conditional triggered event fulfilled first and a conditional triggered event fulfilled later.

Alternatively, first indication information in the secondary cell group failure information is configured to indicate whether the serving cell and/or the at least one neighboring cell is the candidate cell for the conditional primary secondary cell (PSCell) addition or change, where
in response to determining that the serving cell or the neighboring cell is the candidate cell for the conditional primary secondary cell (PSCell) addition or change, the first indication information is a first value.

Alternatively, in response to a primary secondary cell (PSCell) addition or change success, the configuration information for the conditional primary secondary cell (PSCell) addition or change includes whether the serving cell and/or the at least one neighboring cell is the candidate cell for the conditional primary secondary cell (PSCell) addition or change.

Alternatively, in response to determining that the serving cell or the neighboring cell is the candidate cell for the conditional primary secondary cell (PSCell) addition or change, second indication information in the secondary cell group failure information is configured to indicate the conditional configuration information for the conditional primary secondary cell (PSCell) addition or change corresponding to the serving cell or the neighboring cell.

Alternatively, the apparatus is applicable to a situation of detecting that at least one of the following events occurs in the secondary cell group:
a radio link failure for the secondary cell group;
a reconfiguration with synchronization failure of the secondary cell group; or
detecting a beam failure of the primary secondary cell (PSCell) of the secondary cell group while the secondary cell group is deactivated.

Alternatively, the apparatus is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the primary secondary cell (PSCell) of the secondary cell group while the secondary cell group is deactivated.

The examples in a fifth aspect of the disclosure provide a communication apparatus. The apparatus includes a processor and a memory. The memory stores a computer program. The processor executes the computer program stored in the memory, so as to cause the apparatus to execute the method for reporting information according to the examples in the first aspect.

The examples in a sixth aspect of the disclosure provide a communication apparatus. The apparatus includes a processor and a memory. The memory stores a computer program. The processor executes the computer program stored in the memory, so as to cause the apparatus to execute the method for reporting information according to the examples in the second aspect.

The examples in a seventh aspect of the disclosure provide a communication apparatus. The apparatus includes a processor and an interface circuit. The interface circuit is configured to receive a code instruction and transmit the code instruction to the processor. The processor is configured to run the code instruction, so as to cause the apparatus to execute the method for reporting information according to the examples in the first aspect.

The examples in an eighth aspect of the disclosure provide a communication apparatus. The apparatus includes a processor and an interface circuit. The interface circuit is configured to receive a code instruction and transmit the code instruction to the processor. The processor is configured to run the code instruction, so as to cause the apparatus to execute the method for reporting information according to the examples in the second aspect.

The examples in a ninth aspect of the disclosure provide a computer-readable storage medium, configured to store an instruction. The instruction causes the method for reporting information according to the examples in the first aspect to be implemented when executed.

The examples in a tenth aspect of the disclosure provide a computer-readable storage medium, configured to store an instruction. The instruction causes the method for reporting information according to the examples in the second aspect to be implemented when executed.

The examples in an eleventh aspect of the disclosure provide a computer program. The computer program causes a computer to execute the method for reporting information according to the examples in the first aspect when running on the computer.

The examples in a twelfth aspect of the disclosure provide a computer program. The computer program causes a computer to execute the method for reporting information according to the examples in the second aspect when running on the computer.

The examples of the disclosure provide a method and apparatus for reporting information. The specified event occurs in the secondary cell group is detected, and the secondary cell group failure information is transmitted to the network device. The secondary cell group failure information includes the configuration information for the conditional primary secondary cell (PSCell) addition or change, such that when a secondary cell group failure occurs, the configuration information for the conditional primary secondary cell (PSCell) addition or change can also be obtained by the network device, and information about the secondary cell group failure can be more comprehensively obtained by the network device. A conditional primary secondary cell addition or change configuration is obtained, then rationality of the conditional configuration can be analyzed, a configuration of conditional parameters can be further optimized, and communication efficiency of a system can be effectively improved.

In order to implement the above example, the examples of the disclosure further provide a communication apparatus. The communication apparatus includes a processor and a memory. The memory stores a computer program. The processor executes the computer program stored in the memory, so as to cause the apparatus to execute the method shown in the examples of FIGS. 2-5.

In order to implement the above example, the examples of the disclosure further provide a communication apparatus. The communication apparatus includes a processor and a memory. The memory stores a computer program. The processor executes the computer program stored in the memory, so as to cause the apparatus to execute the method shown in the examples of FIG. 6.

In order to implement the above example, the examples of the disclosure further provide a communication apparatus. The communication apparatus includes a processor and an interface circuit. The interface circuit is configured to receive a code instruction and transmit the code instruction to the processor. The processor is configured to run the code instruction to execute the method shown in the examples of FIGS. 2-5.

In order to implement the above example, the examples of the disclosure further provide a communication apparatus. The communication apparatus includes a processor and an interface circuit. The interface circuit is configured to receive a code instruction and transmit the code instruction to the processor. The processor is configured to run the code instruction to execute the method shown in the examples of FIG. 6.

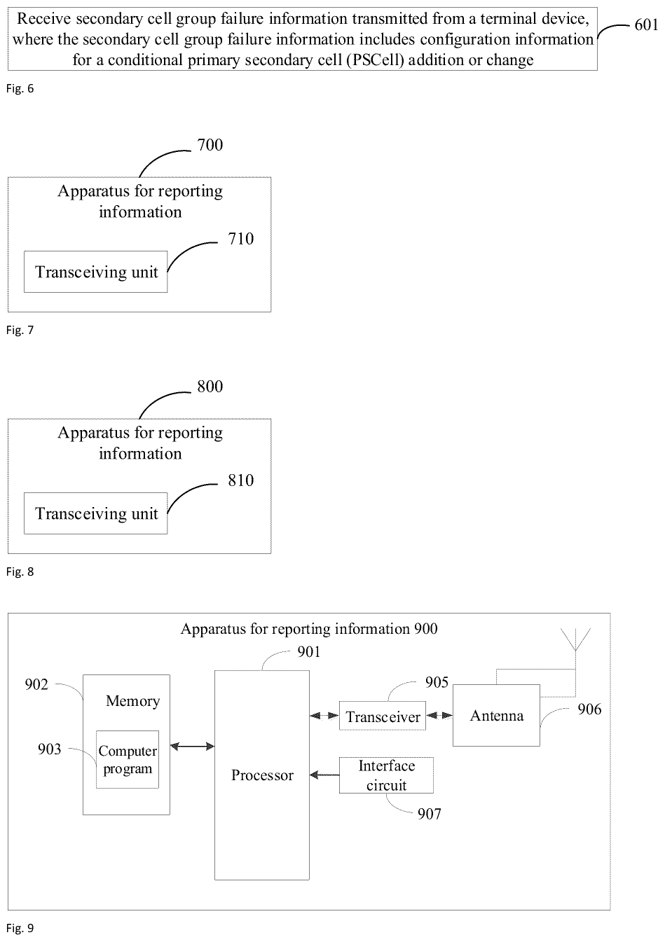

With reference to FIG. 9, FIG. 9 is a schematic structural diagram of another apparatus for reporting information according to an example of the disclosure. The apparatus 900 for reporting information may be a network device, may be a terminal device, may be a chip, a chip system, or a processor that supports a network device to implement the above method, and may also be a chip, a chip system, or a processor that supports a terminal device to implement the above method. The apparatus may be configured to implement the methods described in the above method examples, and reference may be made to description in the above method examples for details.

The apparatus 900 for reporting information may include one or more processors 901. The processor 901 may be a general purpose processor or a special purpose processor, etc., such as a baseband processor or a central processor. The baseband processor may be configured to process a communication protocol and communication data. The central processor may be configured to control an apparatus for reporting information (for example, a base station, a baseband chip, a terminal device, a terminal device chip, a DU or a CU), execute a computer program, and process data of the computer program.

Alternatively, the apparatus 900 for reporting information may further include one or more memories 902 that may store a computer program 903. The processor 901 executes the computer program 903 to cause the apparatus 900 for reporting information to execute the method described in the above method examples. The computer program 903 may be embedded in the processor 901. In this case, the processor 901 may be implemented by hardware.

Alternatively, the memory 902 may also store data. The apparatus 900 for reporting information and the memory 902 may be set separately or may be integrated together.

Alternatively, the apparatus 900 for reporting information may further include a transceiver 905 and an antenna 906. The transceiver 905 may be referred to as a transceiving unit, a transceiving machine, or a transceiving circuit, etc., and is configured to implement a transceiving function. The transceiver 905 may include a receiver and a transmitter. The receiver may be referred to as a receiving machine or a receiving circuit, etc., for implementing a reception function. The transmitter may be referred to as a transmitting machine or a transmitting circuit, etc., for implementing a transmission function.

Alternatively, the apparatus 900 for reporting information may further include one or more interface circuits 907. The interface circuit 907 is configured to receive a code instruction and transmit the code instruction to the processor 901. The processor 901 carry out the code instruction to cause the apparatus 900 for reporting information to execute the method described in the above method examples.

When the apparatus 900 for reporting information is a terminal device, the transceiver 905 is configured to execute steps 201 in FIG. 2, step 301 in FIG. 3. step steps 401 in FIG. 4, and step 501 in FIG. 5.

When the apparatus 900 for reporting information is a network device, the transceiver 905 is configured to execute steps 601 in FIG. 6.

In an implementation, the processor 901 may include a transceiver for implementing a reception function and a transmission function. For example, the transceiver may be a transceiving circuit, or an interface, or an interface circuit. The transceiving circuit, interface, or interface circuit for implementing the reception function and the transmission function may be separated or integrated. The transceiving circuit, interface or interface circuit may be configured to read and write a code/data, and alternatively, the transceiving circuit, interface or interface circuit may be configured to transmit or transfer a signal.

In an implementation, the apparatus 900 for reporting information may include a circuit that may implement the functions of transmission, reception or communication in the foregoing method examples. The processor and transceiver described in the disclosure may be implemented on an integrated circuit (ICs), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The apparatus for reporting information described in the above examples may be a network device or a terminal device. The scope of the apparatus for reporting information described in the disclosure is not limited to this, and a structure of the apparatus for reporting information may not be limited by FIGS. 7-8. The apparatus for reporting information may be a stand-alone device or may be part of a larger device. For example the apparatus for reporting information may be:
(1) an independent integrated circuit (IC), a chip, a chip system or a subsystem;
(2) a set of one or more ICs, alternatively including a memory component for storing data and a computer program;
(3) an ASIC, such as a modem;
(4) a module that can be embedded in other devices;
(5) a receiver machine, a terminal device, an intelligent terminal device, a cellular phone, a radio device, a handset, a mobile unit, a vehicle-mounted device, a network device, a cloud device, an artificial intelligence device, etc.; and
(6) a different apparatus, etc.

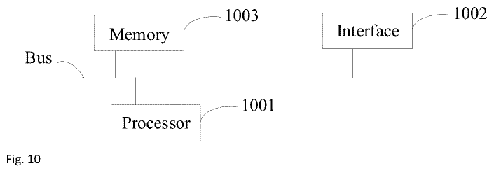

Reference may be made to a schematic structural diagram of a chip shown in FIG. 10 for the case that the apparatus for reporting information may be a chip or a chip system. The chip shown in FIG. 10 includes a processor 1001 and an interface 1002. One or more processors 1001 may be provided. A plurality of interfaces 1002 may be provided.

For the case that the chip is configured to implement the function of the network device in the example of the disclosure:
the interface 1002 is configured to receive a code instruction and transmit the code instruction to the processor; and
the processor 1001 is configured to run the code instruction, so as to execute the method as shown in FIGS. 2-5.

For the case that the chip is configured to implement the function of the terminal device in the example of the disclosure:
the interface 1002 is configured to receive a code instruction and transmit the code instruction to the processor; and
the processor 1001 is configured to run the code instruction, so as to execute the method as shown in FIG. 6.

Alternatively, the chip further includes a memory 1003. The memory 1003 is configured to store a necessary computer program and data.

Those skilled in the art will further appreciate that the various illustrative logical blocks and steps set forth in the examples of the disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation should not be understood to be beyond the scope of protection of the examples of the disclosure.

The examples of the disclosure further provide a communication system. The system includes the apparatus for reporting information serving as a terminal device and the apparatus for reporting information serving as a network device in the examples of FIGS. 7-8. Alternatively, the system includes the apparatus for reporting information serving as a terminal device and the apparatus for reporting information serving as a network device in the example of FIG. 9.

The disclosure further provides a readable storage medium. The readable storage medium stores an instruction. The instruction implements the functions of any one of the method examples when executed by a computer.

The disclosure further provides a computer program product. The computer program product implements the functions of the method examples when executed by a computer.

The examples described above can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the examples of the disclosure. The computer may be a general purpose computer, a special purpose computer, a computer network, or other programmable apparatuses. The computer program may be stored in a computer-readable storage medium or transmitted from one computer-readable storage medium to another computer-readable storage medium. For example, the computer program can be transmitted from one website, computer, server, or data center to another website, computer, server, or data center in a wired way (for example, a coaxial cable, an optical fiber, and a digital subscriber line (DSL)) or a wireless way (for example, infrared, radio waves, and microwaves). The computer-readable storage medium may be any available medium that can be accessed by a computer or a data storage device including one or more available media integrated as a server, data center, etc. The available medium may be a magnetic medium (for example, floppy disk, hard disk, magnetic tape), an optical medium (for example, digital video disc (DVD)), or a semiconductor medium (for example, solid state disk (SSD)), etc.

Those skilled in the art may understand that the first, second and other numerical numbers referred to in the disclosure are merely for distinction for convenience of description, and are not intended to limit the scope of the examples of the disclosure, and also represent the sequence.

At least one in the disclosure may also be described as one or more, and the plurality may be two, three, four, or more, which are not limited to the disclosure. In the examples of the disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” have no sequence or order of magnitude.

Corresponding relations shown in tables of the disclosure may be configured or predefined. Values of information in each table are only instances, and may be configured to other values, which are not limited to the disclosure. When a corresponding relation between the information and each parameter is configured, it is not necessarily required to configure all the corresponding relations indicated in each table. For example, in the tables of the disclosure, the corresponding relations shown in some rows may not be configured. For another example, appropriate deformation adjustments, such as splitting, merging, etc., can be made based on the above table. Names of the parameters shown in the titles of the above tables may also be other names that can be understood by the communication apparatus, and values or expression modes of the parameters may also be other values or expression modes that can be understood by the communication apparatus. When the tables are implemented, other data structures may also be used, such as an array, a queue, a container, a stack, a linear table, a pointer, a linked list, a tree, a graph, a structure, a class, a heap, and a hash table.

Predefinition in the disclosure may be understood as defining, predefining, storing, pre-storing, pre-negotiating, pre-configuring, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled can implement the described functions with different methods for each particular application, but such implementation should not be considered to fall beyond the scope of the disclosure.

Those skilled in the art will clearly appreciate that, for convenience and conciseness of description, reference can be made to corresponding processes in the foregoing method examples for specific working processes of the above systems, devices and units, which are not repeated here.

It should be understood that the various forms of the flows shown above may be used, with steps being reordered, added, or deleted. For instance, steps described in the examples of the disclosure may be executed in parallel, executed sequentially, or executed in a different order, as long as desired results of the technical solutions disclosed in the disclosure can be achieved, which is not limited here.

The above specific embodiments do not limit the scope of protection of the disclosure. Those skilled in the art will appreciate that various modifications, combinations, subcombinations, and substitutions may occur according to design requirements and other factors. Any modifications, equivalent substitutions, improvements, etc. made within the spirit and principle of the disclosure should be included within the scope of protection of the disclosure.

1. A method for reporting information, performed by a terminal device, comprising:
detecting that a specified event occurs in a secondary cell group, and
transmitting secondary cell group failure information to a network device, wherein
the secondary cell group failure information comprises configuration information for a conditional primary secondary cell (PSCell) addition or change.

2. The method for reporting information according to claim 1, wherein the configuration information for the conditional PSCell addition or change comprises at least one of:
whether a serving cell is a candidate cell for the conditional PSCell addition or change;
whether at least one neighboring cell is a candidate cell for the conditional PSCell addition or change;
conditional configuration information for the conditional PSCell addition or change corresponding to the serving cell;
conditional configuration information for the conditional PSCell addition or change corresponding to the at least one neighboring cell; or
triggered event information.

3. The method for reporting information according to claim 2, wherein the conditional configuration information for the conditional PSCell addition or change comprises at least two conditional triggered events, wherein the at least two conditional triggered events comprise a first conditional triggered event and a second conditional triggered event, and the triggered event information comprises:
whether the first conditional triggered event is fulfilled;
whether the second conditional triggered event is fulfilled;
the conditional triggered event fulfilled first; and
a time interval between two conditional triggered events fulfilled.

4. The method for reporting information according to claim 1, wherein the specified event comprises at least one of:
a radio link failure for the secondary cell group;
a reconfiguration with synchronization failure of the secondary cell group; or
detecting a beam failure of the PSCell of the secondary cell group while the secondary cell group is deactivated.

5. The method for reporting information according to claim 2, wherein at least one of:
first indication information in the secondary cell group failure information is configured to indicate whether the serving cell is the candidate cell for the conditional PSCell addition or change, wherein
in response to determining that the serving cell is the candidate cell for the conditional PSCell addition or change, the first indication information corresponding to the serving cell is a first value; or,
the first indication information in the secondary cell group failure information is configured to indicate whether each cell of the at least one neighboring cell is the candidate cell for the conditional PSCell addition or change, wherein
in response to determining that the neighboring cell is the candidate cell for the conditional PSCell addition or change, the first indication information corresponding to the neighboring cell is a the first value.

6. The method for reporting information according to claim 5, wherein in response to the conditional PSCell addition or change success, the configuration information for the conditional PSCell addition or change comprises at least one of:
whether the serving cell is the candidate cell for the conditional PSCell addition or change; or
whether the at least one neighboring cell is the candidate cell for the conditional PSCell addition or change.

7. The method for reporting information according to claim 2, wherein in response to determining that the serving cell or the neighboring cell is the candidate cell for the conditional PSCell addition or change, second indication information in the secondary cell group failure information is configured to indicate conditional configuration information for the conditional PSCell addition or change corresponding to the serving cell or the neighboring cell.

8. The method for reporting information according to claim 1, wherein the method is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the PSCell of the secondary cell group while the secondary cell group is deactivated.

9. A method for reporting information, performed by a network device, comprising:
receiving secondary cell group failure information transmitted from a terminal device, wherein
the secondary cell group failure information comprises configuration information for a conditional primary secondary cell (PSCell) addition or change.

10. The method for reporting information according to claim 9, wherein the configuration information for the conditional PSCell addition or change comprises at least one of:
whether a serving cell is a candidate cell for the conditional PSCell addition or change;
whether at least one neighboring cell is a candidate cell for the conditional PSCell addition or change;
conditional configuration information for the conditional PSCell addition or change corresponding to the serving cell;
conditional configuration information for the conditional PSCell addition or change corresponding to the at least one neighboring cell; or
triggered event information.

11. The method for reporting information according to claim 10, wherein the conditional configuration information for the conditional PSCell addition or change comprises at least two conditional triggered events, wherein the at least two conditional triggered events comprise a first conditional triggered event and a second conditional triggered event, and the triggered event information comprises:
whether the first conditional triggered event is fulfilled;
whether the second conditional triggered event is fulfilled;
the conditional triggered event fulfilled first; and
a time interval between two conditional triggered events fulfilled.

12. The method for reporting information according to claim 10, wherein at least one of:
first indication information in the secondary cell group failure information is configured to indicate whether the serving cell is the candidate cell for the conditional PSCell addition or change, wherein
in response to determining that the serving cell is the candidate cell for the conditional PSCell addition or change, the first indication information corresponding to the serving cell is a first value; or,
the first indication information in the secondary cell group failure information is configured to indicate whether each cell of the at least one neighboring cell is the candidate cell for the conditional PSCell addition or change, wherein
in response to determining that the neighboring cell is the candidate cell for the conditional PSCell addition or change, the first indication information corresponding to the neighboring cell is the first value.

13. The method for reporting information according to claim 12, wherein in response to the conditional PSCell addition or change success, the configuration information for the conditional PSCell addition or change comprises at least one of:
whether the serving cell is the candidate cell for the conditional PSCell addition or change; or
whether the at least one neighboring cell is the candidate cell for the conditional PSCell addition or change.

14. The method for reporting information according to claim 10, wherein in response to determining that the serving cell or the neighboring cell is the candidate cell for the conditional PSCell addition or change, second indication information in the secondary cell group failure information is configured to indicate conditional configuration information for the conditional PSCell addition or change corresponding to the serving cell or the neighboring cell.

15. The method for reporting information according to claim 9, wherein the method is applicable to a situation of detecting that at least one of the following events occurs in the secondary cell group:
a radio link failure for the secondary cell group;
a reconfiguration with synchronization failure of the secondary cell group; or
detecting a beam failure of the PSCell of the secondary cell group while the secondary cell group is deactivated.

16. The method for reporting information according to claim 9, wherein the method is inapplicable to a situation of detecting that at least one of the following events occurs in the secondary cell group:
an integrity check failure from secondary cell group lower layers concerning signaling radio bearer type 3 (SRB3);
a secondary cell group configuration failure; or
detecting a beam failure of the PSCell of the secondary cell group while the secondary cell group is deactivated.

17-32. (canceled)

33. A communication apparatus, comprising one or more processors and a memory, wherein the one or more processors are collectively configured to:
detect that a specified event occurs in a secondary cell group, and transmit secondary cell group failure information to a network device, wherein
the secondary cell group failure information comprises configuration information for a conditional primary secondary cell (PSCell) addition or change.

34. A communication apparatus, comprising a processor and a memory, wherein the memory stores a computer program, and the processor executes the computer program stored in the memory, so as to cause the apparatus to execute the method for reporting information according to claim 9.

35-36. (canceled)

37. A non-transitory computer-readable storage medium, configured to store an instruction, wherein the instruction causes the method for reporting information according to claim 1 to be implemented when executed.

38. A non-transitory computer-readable storage medium, configured to store an instruction, wherein the instruction causes the method for reporting information according to claim 9 to be implemented when executed.
